(19) United States
(12) Patent Application Publication
(10) Pub. No.: US 2012/0096257 A1
(43) Pub. Date: Apr. 19, 2012

(54) Apparatus and Method for Protecting Storage Data of a Computing Apparatus in an Enterprise Network System

(75) Inventors: Yan Li, Beijing (CN); Hai Bo Lin, Beijing (CN); Tao Liu, Beijing (CN); Ji Tao Xu, Beijing (CN); Yu Dong Yang, Beijing (CN)

(73) Assignee: INTERNATIONAL BUSINESS MACHINES CORPORATION, Armonk, NY (US)

(21) Appl. No.: 13/249,448

(22) Filed: Sep. 30, 2011

(30) Foreign Application Priority Data
Sep. 30, 2010 (CN) 201010506473.0

(51) Int. Cl. G06F 12/14

(52) U.S. Cl. 713/150

(57) ABSTRACT

The present invention relates to data security, in particular relates to data protection for storage data, and more particularly relates to encrypting and decrypting process to data on a removable non-volatile storage in an enterprise network. There is provided an apparatus and a method for protecting storage data of a computing apparatus within an enterprise network system, the method comprising: intercepting data transferred between an application of the computing apparatus and a storage; determining whether the data intercepted at the data transfer interception step is confidential data; obtaining a key automatically generated for the confidential data; and encrypting and decrypting the confidential data with the obtained key.

### CROSS-REFERENCE TO RELATED APPLICATION(S)

This application claims foreign priority to P.R. China Patent application 201010506473.0 filed 30 Sep. 2010, the complete disclosure of which is expressly incorporated herein by reference in its entirety for all purposes.

### FIELD OF THE INVENTION

The present invention relates to data security, in particular relates to data protection for storage data, and more particularly relates to an encrypting and decrypting process to data on a removable non-volatile storage in an enterprise network.

### BACKGROUND OF THE INVENTION

A removable non-volatile storage such as an optical disk, a hard disk, and a mobile storage, etc., is a data storage prevalently used in a computing apparatus. Since a mobile storage has a fast data transfer rate and a compact size, it becomes increasingly prevalent. An auxiliary storage in many portable electronic devices such as a mobile phone, a digital camera, etc., may also be used as a mobile storage. With a mobile storage, it is convenient for a user to store information on a mobile storage so as to be used in different computing apparatuses. In fact, an enterprise user always stores sensitive or confidential information of the enterprise on a mobile storage so as to facilitate exchange in different venues or between different employees. It is allowed within the enterprise or between enterprise employees. However, if the mobile storage is lost or stolen, confidential information of the enterprise will be divulged to a person outside the enterprise who has no access right to the confidential information.

The prior art provides various solutions for protecting mobile storage data. One solution is that an operating system provides encryption to a data file, and another solution is to provide an encryption function by the mobile storage device. Once this encryption function is enabled, all data in the storage (for example files) are encrypted. These manners are not transparent to a user. The user, when writing data to the storage. must set a password, and when reading data from the storage, must provide the set password.

### SUMMARY OF THE INVENTION

An objective of the present invention is to provide an improved solution for ensuring data security in a mobile storage in an enterprise network environment.

According to an aspect of the present invention, there is provided a storage data protector for a computing apparatus within an enterprise network system, comprising: data transfer intercepting means for intercepting data transferred between an application in the computing apparatus and a storage; confidential data determining means for determining whether the data intercepted by the data transfer intercepting means is confidential data; key obtaining means for obtaining a key automatically generated for the confidential data: encrypting and decrypting means for encrypting and decrypting confidential data with the key obtained by the key obtaining means.

According to another aspect of the present invention, there is provided a method of protecting storage data of a computing apparatus within an enterprise network system, comprising: intercepting data transferred between an application of the computing apparatus and a storage; determining whether the data intercepted at the data transfer interception step is confidential data; obtaining a key automatically generated for the confidential data; and encrypting and decrypting the confidential data with the obtained key.

An advantage of the present invention lies in safety and convenience, which is applicable for an enterprise network environment. On one hand, a key is generated independently from a network terminal and a storage, but stored collectively, which cannot be obtained outside an enterprise network; and on the other hand, the key is automatically generated by the server, wherein encryption and decryption may be automatically performed to the confidential data without requiring a user of the application to enter the key. Such automatic and transparent encrypting and decrypting manner to the storage data is particularly advantageous for storing the confidential data or document on a mobile storage, while ensuring that the enterprise implements the data confidential rule, such that intercommunication between different applications and interoperability between enterprise users are enabled.

### BRIEF DESCRIPTION OF THE DRAWINGS

Inventive features regarded as the characteristics of the present invention are set forth in the Summary of the Invention section and the appended claims. However, the present invention, its implementation mode, other objectives, features and advantages will be better understood through reading the following detailed description on the exemplary embodiments with reference to the accompanying drawings, in which:

FIG. 1A is a diagram of an enterprise network system in which various embodiments of the present application may be applied;

FIG. 1B shows a diagram of a system 10B according to an embodiment of the present invention;

FIG. 2 shows a schematic block diagram of a mobile storage data protector 20 according to an embodiment of the present invention;

FIG. 3 shows a schematic block diagram of a storage data security server 30 according to an embodiment of the present invention; and

FIG. 4 schematically shows a flow chart of a method according to an embodiment of the present invention.

### DETAILED DESCRIPTION OF PREFERRED EMBODIMENTS

Hereinafter, embodiments of the present invention will be described with reference to the accompanying drawings. In the following description, many specific details are illustrated so as to understand the present invention more comprehensively. However, it is apparent to the skilled in the art that implementation of the present invention may not have these details. Additionally, it should be understood that the present invention is not limited to the particular embodiments as introduced here. On the contrary, any arbitrary combination of the following features and elements may be considered to implement and practice the present invention, regardless of whether they involve different embodiments. Thus, the following aspects, features, embodiments and advantages are only for illustrative purposes, and should not be construed as elements or limitations of the appended claims, unless otherwise explicitly specified in the claims.

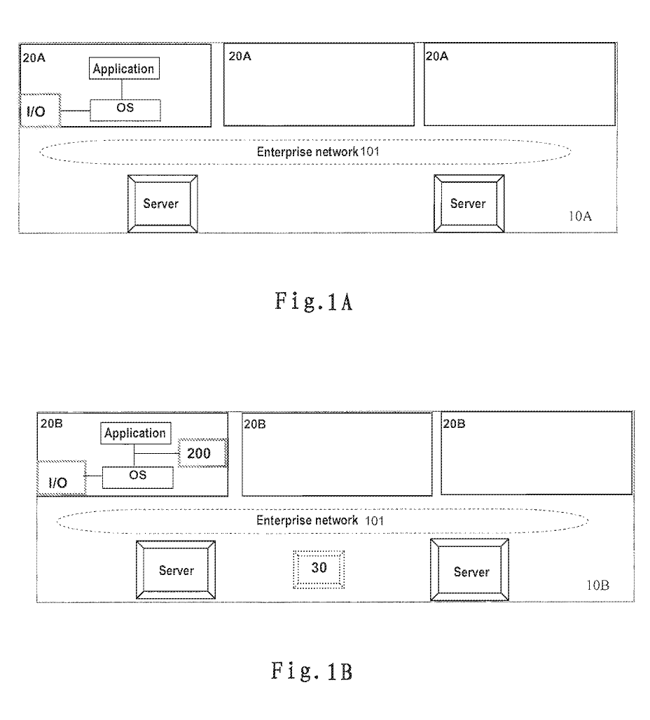

FIG. 1A schematically shows a diagram of an enterprise network system in which various embodiments of the present application may be applied. The enterprise network system 10A as shown in FIG. 1A comprises one or more computing apparatuses 20A, an enterprise network 101, and one or more servers. The computing apparatus 20A is communicatively connected to the server via the enterprise network 101. The enterprise network 101 is isolated from an external network to prevent access of an unauthenticated user.

The computing apparatus 20A of the system 10A may be various kinds of independent computing platforms, such as a small one like a personal computer, and a big one like a server; the computing apparatus 20A is configured with an operating system OS, for example Windows by Microsoft, Linux, MAC, etc. The computing apparatus 20A is also configured with various kinds of applications, such as MS Word, Excel, etc.

A user or an application of the computing apparatus 20A may write data to a removable non-volatile storage (hereinafter referred as “storage”) in communication with an input/output interface I/O, or read data from the storage. For example, when a user is running an application (for example MS Word), he/she may issue a command in the application to write a file of the application to a storage through a file system of the operating system, or read a file of the application from the storage. For example, the application Word may write a Word document to a storage through a file system of the operating system Windows, or read a Word document from the storage.

FIG. 1B shows a diagram of an enterprise network system deployed with a system according to an embodiment of the present invention. A system 10B as shown in FIG. 1B comprises a computing apparatus 20B and a storage data security server 30, where the computing apparatus 20B and the storage data security server 30 are communicatively connected through an enterprise network 101.

In FIG. 1B, the storage data security server 30 is indicated by a dotted-line block, which indicates that the storage data security server 30 may be an individual server, or its functions may be integrated on other servers, or its functions are implemented on other existing servers.

The enterprise network 101 and the computing apparatus 20B as shown in FIG. 1B have substantially the same structure and function as the enterprise network 101 and the computing apparatus 20A in the above described FIG. 1A. For example, the computing apparatus 20B is also configured with an operating system and applications, wherein the applications may perform data read/write operations to the storage connected via I/O.

According to an embodiment of the present invention, the computing apparatus 20B of the system 10B as shown in FIG. 1B further comprises a storage data protector 200.

The storage data protector 200 is for intercepting data transferred between the application and the storage in the computing apparatus 20B within the enterprise network system 10B and performs encrypting and decrypting to the confidential data in the intercepted data.

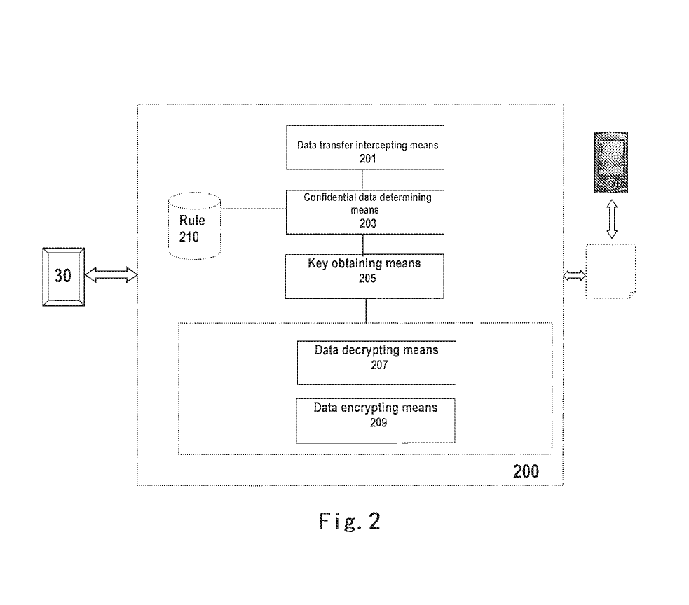

Various embodiments and functions of the storage data protector 200 will be described hereinafter in more detail with reference to FIG. 2.

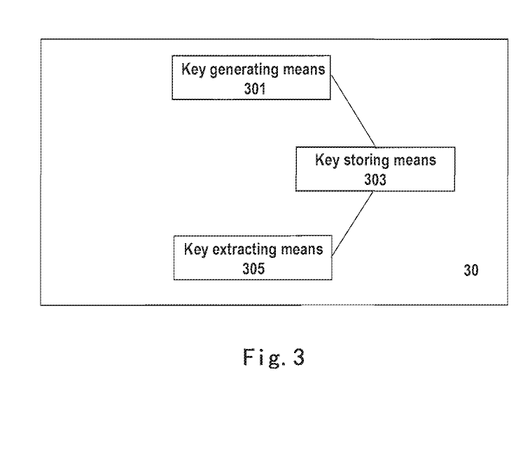

According to the present invention, the storage data security server 30 of the system 10B as shown in FIG. 1B is for generating and saving a key for confidential data in response to a request from the computing apparatus. Various embodiments and functions of the storage data security server 30 will be described hereinafter in more detail with reference to FIG. 3.

FIG. 2 schematically shows a block diagram of a storage data protector 200 according to an embodiment of the present invention. As shown in FIG. 2, the storage data protector 200 according to an embodiment of the present invention comprises: data transfer intercepting means 201, confidential data determining means 203, key obtaining means 205, encrypting means 209, and decrypting means 207.

The data transfer intercepting means 201 is for intercepting data transferred between an application and an operating system in the computing apparatus 20B within the enterprise network.

A data request for storage data from a user or application of the computing apparatus 20B comprises read data request and write data request. The read data request is to read data from the storage, i.e. reading storage data, for example opening a data file on the storage; the write data request is to write data to the storage, i.e., writing storage data, for example storing a storage data file on the storage.

The skilled artisan knows that the data operation to a peripheral device such as a storage by a user with an application in the computing apparatus 20B may be implemented by a file system of an operating system. For example, when a user is running an application (for example MS WORD), he/she may issue a write command (for example “open file”) or read command (for example “save file”) to the storage. The file system of the operating system, responsive to the write command or read command, writes a target file to the non-volatile storage, or reads the target file from the non-volatile storage.

The read data operation or write data operation is directed to data transferred between the application and the storage, and such data may be intercepted. For example, in the prior art, a filter drive layer may be added between the file system and the application, for intercepting data transfer. Thus, in implementing the present invention, the function of data transfer intercepting means 201 may be performed through such filter drive layer between the file system and the application.

The confidential data determining means 203 is for determining whether the data intercepted by the data transfer intercepting means 201 is confidential data.

The prior art has already proposed various kinds of technologies for determining whether data are confidential data, some of which predefine certain rules to prescribe which data are confidential data. During the user's operation, whether data relating to a read or write operation are confidential data may be determined according to predetermined rules.

According to an embodiment of the present invention, in an environment of an enterprise network system, whether data relating to a read or write operation are confidential data may be determined through interaction with the user or based on a compulsory predetermined confidential rule of the enterprise. For example, whether a target file is confidential document is determined by checking the file attributes and/or content of the target file subject to the read operation and write operation.

For example, for a user's read operation to the storage, whether it is encrypted by a storage data protector 200 of other computing apparatus may be checked by file properties of a target file subject to read operation. If the target file of the read operation is encrypted, then this target file is confidential data.

As shown in FIG. 2, the confidential data determining means 203 may, for example for the user's read operation to the storage, identify in default that the target file subject to the read operation is confidential data under a predetermined confidential rule based on a confidential rule library 210; if the target file already exists, then whether confidential identifier such as “Confidential” exists in the target file may be checked; if the confidential identifier exists, then it is determined that this target file is confidential data; if the user removes such confidential identifier during the process of editing an existing data file, then the content of the target file may be checked, where if sensitive information such as sensitive sentences prescribed in the predetermined rule is detected, then it is determined that the target file is confidential data, or an alarm is issued to the user to request the user to confirm whether it is confidential data, and so forth.

The key obtaining means 205 is for obtaining a key automatically generated for the confidential data. In other words, if the confidential data determining means 203 determines that the data intercepted by the data transfer intercepting means 201 is confidential data, then the key obtaining means 205 is to obtain a key for the intercepted data. The key is not user entered, but automatically generated by the machine.

Of course, if the determining result of the confidential data determining means 203 shows that the data intercepted by the data transfer intercepting means 201 is not confidential data, then the key obtaining means 205 need not obtaining a key for the intercepted data. In this case, the intercepted data will be returned to the original data transfer path and read to the application or written to the storage normally. Processing non-confidential data is not a focus of this invention and is thus not detailed here.

According to an embodiment of the present invention, the key obtaining means 205 further comprises an identifier calculating means, for calculating a unique identifier of the confidential data based on the confidential data. For example, the identifier calculating means may use a hash function to calculate a hash value with the target file as the confidential data as a variant of the hash function, for example md5 value, and then this hash value is taken as the unique identifier of the target file.

Correspondingly, the key obtaining means 205 may, responsive to a determination of the confidential data determining means 203 that the data intercepted by the data transfer intercepting means 201 is confidential data, obtain a key with a unique identifier representing the confidential data. For example, the key obtaining means 205 may send the unique identifier along with a key request to the storage data security server 30 within the enterprise network, and then receive a key returned from the storage data security server 30.

The unique identifier calculated from the Hash function may guarantee the uniqueness of the unique identifier. In contrast, for a solution such as an identifier of a file name, since different users inside the enterprise may use a same file name for different files, a problem of identical file name may exist.

According to an embodiment of the present invention, the storage data protector 200 comprises a read/write determining means (not shown) to determine whether intercepted data is read data (data read by an application from the storage) or write data (data stored to a storage by an application). In a specific implementation, a determining result of whether it is a read data request or a write data request may be simply derived based on the type of the data request to a storage data from a user or an application, and the “read” or “write” signal indicating this type is accompanied with a data stream between the application and the storage, which therefore may be intercepted as well. Obviously, the read/write determining means may be included in the data transfer intercepting means 201, which, of course, may be included in the confidential data determining means 203.

The encrypting means 209 is for encrypting the confidential data with the key obtained by the key obtaining means 205.

More specifically, the encrypting means 209 encrypts the confidential data involved in the write data request from the application with the key obtained by the key obtaining means 205.

According to an embodiment, the encrypting means 209 is configured to, responsive to the data intercepted by the read/write determining means being write data, encrypt the confidential data with the key obtained by the key obtaining means 205.

The decrypting means 207 is for decrypting the confidential data with the key obtained by the key obtaining means 205. More specifically, the decrypting means 207 decrypts the confidential data involved in the read data request from the application with the key obtained by the key obtaining means 205.

According to an embodiment of the present invention, the decrypting means 207 is configured to, responsive to the data intercepted by the read/write determining means being read data, decrypt the confidential data with the key obtained by the key obtaining means 205.

It should be noted that the encrypting manner of the encrypting means 209 to the data and the decrypting manner of the decrypting means 207 to the data are not focuses of this invention. When implementing the present invention, those skilled in the art may adopt any encrypting/decrypting technology existing in the prior art or developed in the future to implement the functions of the encrypting means and decrypting means of the present invention.

Further, the encrypting means 209 and the decrypting means 207 as shown in FIG. 2 are separate, which do not limit various embodiments of the present invention; those skilled in the art obviously understand that a single encrypting/decrypting means may be used to implement the present invention. According to customary knowledge of those skilled in the art, the “encrypting/decrypting means” here is the general term for encrypting means 209 and decrypting means 207.

FIG. 3 shows a storage data security server 30 according to an embodiment of the present invention. As above discussed with reference to FIG. 1B, the storage data security server 30 is for generating and saving a key for confidential data in response to a request from the computing apparatus 20B.

As shown in the figure, the storage data security server 30 according to an embodiment of the present invention comprises: key generating means 301, key storing means 303, and key extracting means 305.

The key generating means 301 is for generating a key in response to a request from the key obtaining means 205 of the computing apparatus 20B.

The prior art has proposed various kinds of techniques or algorithms for generating a key for data or a file, for example symmetric cryptography algorithm (single key cryptographic algorithm) and asymmetric cryptography algorithm (public key cryptographic algorithm). A block cipher algorithm may also be used for digital signature. Common encryption standards comprise: DES, Tripl-DES, RC2, RC4, CAST, etc. A public key cryptography algorithm may also be used for digital signature, and common encryption standards comprise: RSA, DSA, etc. To implement the present invention, one or more algorithms or their combination in the prior art may be used, which will not be detailed here.

The key storing means 303 is for storing the generated key along with an associated identifier of the confidential data in a corresponding manner.

To specifically implement the present invention, a single storage may be used, or other storages may be leveraged to store the key and information representing an identifier in an exactly corresponding manner, which identifier should uniquely represent an identifier of the confidential data associated with the key.

The key extracting means 305 is for extracting a corresponding key from the key storing means 203 based on the identifier of the confidential data.

To implement the present invention, when a key request is received from the computing apparatus 20B, the key extracting means 305 firstly searches whether an identifier received with the request exists in the key storing means 203, and if there exists, a corresponding key should also be saved in the key storing means 203. Then, the key corresponding to the identifier should be read. The key will be returned to the requesting computing apparatus 20B through the enterprise network, as a response to the key request as issued thereby.

If the key storing means 203 has no identifier received with the request, then the key generating means 301 generates a key for the identifier; the key will be returned to the requesting computing apparatus 20B through the enterprise network, as a response to the key request issued thereby. Meanwhile, the key generated by the key generating means 301 and the corresponding identifier are stored in the key storing means 203.

It should be noted that according to the present invention, the key is generated and saved collectively on the server, and thus generation and save of the key is isolated from the computing apparatus of the user, which therefore has a reliable security.

A storage data protector 200 of a computing apparatus within an enterprise network system, a storage data security server 30, and a system comprising the computing apparatus including the storage data protector 200, and the storage data security server 30 according to various embodiments of the present invention have been described above. According to a general inventive concept, the present invention further provides a method for protecting storage data of a computing apparatus 20B within an enterprise network system.

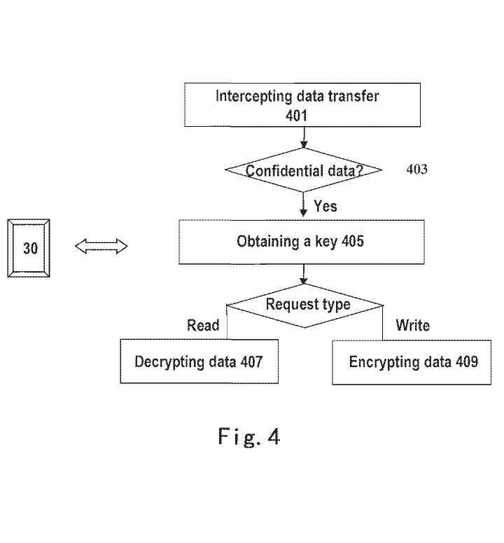

FIG. 4 schematically shows a flow chart of a method according to an embodiment of the present invention. Referring to FIG. 4, the process of this method starts from a data transfer interception step 401, where data transferred between an application in the computing apparatus 20B and a storage device is intercepted.

Then, a confidential data determining step 403 is implemented to determine whether the data intercepted at the data transfer interception step 401 is confidential data.

If the data intercepted at step 401 is not confidential data, no process is performed to the intercepted data. The data is normally read to the application or stored to the storage. If the intercepted data is confidential data, then the process proceeds to a key obtaining step 405.

At the key obtaining step 405, a key automatically generated for the confidential data is obtained. After obtaining the key, the process proceeds to an encrypting/decrypting step 407/409.

At the encrypting/decrypting step 407/409, encrypting or decrypting is performed on confidential data with the key obtained at the key obtaining step 405. The encrypted or decrypted data will be returned to the original data transfer path and written into the storage or read to the application.

According to an embodiment of the present invention, the key obtaining step of the above method further comprises an identifier calculating step, which step, responsive to the determination of the confidential data determining step 403 that the intercepted data is confidential data, is for computing a unique identifier based on the intercepted data, to obtain a key automatically generated for the intercepted data.

According to an embodiment of the present invention, at the key obtaining step 405, the unique identifier as calculated together with a key request is further sent to the storage data security server 30 within the enterprise network, and then the key returned from the storage data security server 30 is received.

According to an embodiment of the present invention, encrypting or decrypting is performed to the intercepted data after obtaining the key. Specifically, if the intercepted data is to be written. i.e., data to be stored to the storage, then the intercepted data is encrypted with the obtained key, and the encrypted data will be returned to the original data transfer path so as to be stored in the storage. If the intercepted data is to be read, i.e., data to be read by the application from the storage, then the intercepted data is decrypted with the obtained key, and the decrypted data will be returned to the original data transfer path so as to be opened in the application.

During implementation of the present invention, a confidential rule library may be set on the computing apparatus to preset enterprise confidential rules based on which whether the intercepted data is confidential data is determined. In this way, even if the user of the computing apparatus, for example, fails to initiatively adopt a confidential measure to the confidential data due to neglect when storing data on a mobile storage, this confidential data may also be automatically encrypted.

What is described above is a method for protecting storage data of a computing apparatus 20B within the enterprise network system according to embodiments of the present invention. Since a storage data protector 200 of a computing apparatus within an enterprise network system, a storage data security server 30, and a system comprising the computing apparatus including the storage data protector 200, and the storage data security server 30 according to various embodiments of the present invention have been previously described in detail, those contents which repeat obviously with the depictions on the storage data protector 200 and storage data security server 30 or which can be easily derived from the depictions on the storage data protector 200 and storage data security server 30 are omitted in the above description on the method.

The automatic and transparent encrypting and decrypting manners to storage data according to various embodiments of the present invention are particularly advantageous in ensuring implementation of data confidential rules by the enterprise, and meanwhile the confidential data or file is saved on the mobile storage, which is advantageous for intercommunication between different applications and interoperability between enterprise users.

By virtue of the present invention, even if the mobile storage used inside an enterprise network is lost or stolen, the enterprise confidential information on the mobile storage will not be divulged to a person who gets the mobile storage but has no right to access the confidential information.

It should be noted that the above depiction is only exemplary, not intended for limiting the present invention. In other embodiments of the present invention, this method may have more, or less, or different steps, and numbering the steps is only for making the depiction more concise and much clearer, but not for stringently limiting the sequence between each steps, while the sequence of steps may be different from the depiction. For example, in some embodiments, the above one or more optional steps may be omitted. Specific embodiment of each step may be different from the depiction. All these variations fall within the spirit and scope of the present invention.

The present invention may be implemented by hardware, software, or combination of hardware and software. The present invention may be implemented in a computer system in a collective or distributive manner, wherein in the distributive manner, different parts are distributed in a plurality of interconnected computer systems. Any computer system or other apparatus suitable for implementing the method as depicted herein may be employed. A typical combination of hardware and software may be a universal compute system with a computer program which, when being loaded and executed, controls the computer system to implement the method of the present invention and constitutes the means of the present invention.

The present invention may also be embodied in the computer program product which comprises all features capable of implementing the method as depicted herein and may implement the method when loaded to the computer system.

The present invention has been specifically illustrated and explained with reference to the preferred embodiments. The skilled in the art should understand various changes thereto in form and details may be made without departing from the spirit and scope of the present invention.

Thus, having reviewed the disclosure herein, the skilled artisan will appreciate that aspects of the present invention may take the form of a computer program product embodied in one or more computer readable medium(s) having computer readable program code embodied thereon. Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Distinct software modules for carrying aspects of embodiments of the invention can be, in at least some cases, embodied on a computer readable storage medium

The means mentioned herein can include (i) hardware module(s), (ii) software module(s), or (iii) a combination of hardware and software modules; any of (i)-(iii) implement the specific techniques set forth herein, and the software modules are stored in a computer readable medium (or multiple such media).

Though a plurality of exemplary embodiments of the present invention have been illustrated and depicted, the skilled in the art would appreciate that without departing from the principle and spirit of the present invention, changes may be made to these embodiments, and the scope of the present invention is limited by the appending claims and equivalent variations thereof.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A storage data protector of a computing apparatus within an enterprise network system, comprising:
data transfer intercepting means, for intercepting data transferred between an application in the computing apparatus and a storage;
confidential data determining means, for determining whether the data intercepted by the data transfer intercepting means is confidential data;
key obtaining means, for obtaining a key automatically generated for the confidential data; and
encrypting/decrypting means, for encrypting/decrypting the confidential data with the key obtained by the key obtaining means.

2. The storage data protector according to claim 1, wherein the key obtaining means further comprises identifier calculating means for, responsive to the determination by the confidential data determining means that the data intercepted by the data transfer intercepting means is confidential data, calculating a unique identifier based on the intercepted data, to obtain a key automatically generated for the intercepted data.

3. The storage data protector according to claim 2, wherein the key obtaining means is further for:
sending the unique identifier along with a key request to a storage data security server of the enterprise network system; and
receiving a key returned from the storage data security server.

4. The storage data protector according to claim 3, further comprising read/write determining means, for determining whether the intercepted data is read data or write data.

5. The storage data protector according to claim 4, wherein the encrypting/decrypting means, responsive to a determination by the read/write determining means that the intercepted data is write data, encrypts the intercepted data with the key obtained by the key obtaining means.

6. The storage data protector according to claim 4, wherein the encrypting/decrypting means, responsive to a determination by the read/write determining means that the intercepted data is read data, decrypts the intercepted data with the key obtained by the key obtaining means.

7. The storage data protector according to claim 5, further comprising a settable confidential rule library, wherein the confidential data determining means, based on a preset enterprise confidential rule in the confidential rule library, determines whether the data intercepted by the data transfer intercepting means is confidential data.

8. A method for protecting storage data of a computing apparatus within an enterprise network system, comprising:
intercepting data transferred between an application in the computing apparatus and a storage;
determining whether the intercepted data is confidential data;
obtaining a key automatically generated for the confidential data; and
carrying out at least one of encrypting and decrypting of the confidential data with the obtained key.

9. The method according to claim 8, wherein the step of obtaining the key automatically generated for the confidential data further comprises:
calculating a unique identifier based on the intercepted data, responsive to a determination that the intercepted data is confidential data, for obtaining the key automatically generated for the intercepted data.

10. The method according to claim 9, wherein the step of obtaining the key automatically generated for the confidential data further comprises:
sending the unique identifier along with a key request to a storage data security server of the enterprise network system; and
receiving a key returned from the storage data security server.

11. The method according to claim 9, further comprising:
determining whether the intercepted data is read data or write data.

12. The method according to claim 11, wherein the step of carrying out at least one of encrypting and decrypting of the confidential data with the obtained key comprises:
encrypting the intercepted data with the key obtained at the key obtaining step, responsive to a determination that the intercepted data is write data.

13. The method according to claim 11, wherein the step of carrying out at least one of encrypting and decrypting of the confidential data with the obtained key comprises:
decrypting the intercepted data with the key obtained at the key obtaining step, responsive to a determination that the intercepted data is read data.

14. The method according to claim 11, wherein the step of determining whether the intercepted data is confidential data comprises determining whether the data intercepted at the data transfer step is confidential data based on an enterprise confidential rule preset in a confidential rule library.

15. A system for protecting storage data in a computing apparatus within an enterprise network system, comprising:
a computer apparatus comprising a storage data protector; and
a storage data security server, coupled to said computer apparatus, for generating and saving a key for confidential data, responsive to a request from the computing apparatus;
wherein said storage data protector in turn comprises:
data transfer intercepting means, for intercepting data transferred between an application in the computing apparatus and a storage;
confidential data determining means, for determining whether the data intercepted by the data transfer intercepting means is confidential data;
key obtaining means, for obtaining a key automatically generated for the confidential data; and
encrypting/decrypting means, for encrypting/decrypting the confidential data with the key obtained by the key obtaining means.

16. The system according to claim 15, wherein the key obtaining means further comprises identifier calculating means for, responsive to the determination by the confidential data determining means that the data intercepted by the data transfer intercepting means is confidential data, calculating a unique identifier based on the intercepted data, to obtain a key automatically generated for the intercepted data.

17. The system according to claim 16, wherein the key obtaining means is further for:
sending the unique identifier along with a key request to a storage data security server of the enterprise network system; and
receiving a key returned from the storage data security server.

18. The system according to claim 17, further comprising read/write determining means, for determining whether the intercepted data is read data or write data.

19. The system according to claim 18, wherein the encrypting/decrypting means, responsive to a determination by the read/write determining means that the intercepted data is write data, encrypts the intercepted data with the key obtained by the key obtaining means.

20. The system according to claim 18, wherein the encrypting/decrypting means, responsive to a determination by the read/write determining means that the intercepted data is read data, decrypts the intercepted data with the key obtained by the key obtaining means.
